(19) United States
(12) Patent Application Publication
(10) Pub. No.: US 2004/0125957 A1
(43) Pub. Date: Jul. 1, 2004

(54) Method and system for secure distribution

(76) Inventors: Ty Rauber, Allston, MA (US); Ted Healey, Winthrop, MA (US)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/664,378

(22) Filed: Sep. 17, 2003

Related U.S. Application Data
(63) Continuation-in-part of application No. 09/546,813, filed on Apr. 11, 2000.
(60) Provisional application No. 60/411,451, filed on Sep. 17, 2002.

(51) Int. Cl. H04L 9/00

(52) U.S. Cl. 380/259

(57) ABSTRACT

A system and method provides for the distribution of artistic works in electronic formats within an organization. The system includes a gateway server and desktop client that enables a user upload and store, on the gateway server, an encrypted copy of the digital content and define an encrypted ticket unique to each user granted access to the digital content. In order to access the encrypted digital content, a user obtains the encrypted ticket. The ticket is encrypted with the user's public key and includes a symmetric key that can be used to decrypt the digital content as well as access control or rights management information that can be used to control user access to the digital content. The user's private key can be used to decrypt the ticket to obtain the symmetric key in order to decrypt the digital content. The access control or rights management information can be used to determine whether the user is permitted to decrypt the digital content as well as what the user can do with the decrypted digital content if access is granted. The system and method can be used in the production environment to control access and distribution of pre-production versions of music and video works as well as draft book manuscripts and other digital content.

### CROSS-REFERENCE TO RELATED APPLICATIONS

This application is a Continuation-in-part of U.S. Ser. No. 09/546,813, filed Apr. 11, 2000, which is hereby incorporated by reference in its entirety.

This application claims the benefit of U.S. Serial No. 60/411,451 entitled “Method and System for Secure Distribution,” filed Sep. 17, 2002, which is hereby incorporated by reference in its entirety.

### STATEMENT REGARDING FEDERALLY SPONSORED RESEARCH

Not Applicable

### REFERENCE TO MICROFICHE APPENDIX

Not Applicable

### BACKGROUND OF THE INVENTION

This invention relates to secure methods and systems for distributing digital content, such as audio, video, and text works and, more particularly, to a method and system for providing controlled distribution of digital content within an enterprise.

Traditionally, entertainment and artistic works such as music and movies are distributed by incorporating a copy of the work in a medium from which the work, such as a song or a movie, can be heard or viewed using a device. For example, music is distributed on records, tapes and compact discs (CDs) and movies are distributed on tapes and digital video or versatile disks (DVDs). The technologies associated with these media have developed over time in order to permit very high quality reproductions of the original work.

The technology also exists to record directly or convert these works into digital data that can be stored in memory in a computer or distributed via a network. This technology permits the works to be stored in a high quality format on digital media such as CDs and DVDs for consumer sale. These technologies can also be used during the production process whereby works or portion of works can be recorded directly in a digital data format or converted to digital data during the production process.

During the production process, works or portions of works must be reviewed and possibly edited by various people involved in the production process. Where the people involved are not in the same location, copies of works or portions of the works must be recorded on tape or a compact disc and shipped to various locations where those people involved can review the works or portions of works. This process is inefficient because even with next day delivery, there is at least a day lag between the time the work (or portion thereof) is created and the time it is reviewed by the person or persons not in the same location that the work was created. In the case of musical recordings, for every master recording a mixing board must be setup for each song and it is impractical to hold the mixing board settings for several days while a copy of the recording is shipped to and reviewed by a producer or executive in another location.

After the final version of the work or portion of the work is completed, one or more master recordings of the work are prepared for distribution to facilities that will make copies packaged for retail sales. In addition, pre-release copies are also prepared for marketing and promotional purposes. These copies are also distributed using either the public postal system or private couriers.

One of the most significant problems with the distribution of these pre and post production copies is that illegal copies can be made and distributed over private and public networks such as the Internet. Thus, it is desirable to enable the production company to distribute pre and post production copies of their works with the ability to control access to and the ability to make copies of these works or portions of works.

Similarly, the public and private networks allow for the retail sale and distribution of works in digital form without the use of a carrier medium such as a CD-ROM or DVD. Because these works are in digital form, they can be easily redistributed using the same public and private networks. In addition, technologies have been developed which enable the works to be compressed into about one tenth the size (of retail distribution) but still maintain nearly the same high quality in play back. One such technology, MPEG 1, audio layer 3, which is more commonly known as MP3, defines how digital audio can be stored and transmitted using computers and networks. Other formats and technologies currently exist and still others are being developed. These technologies and formats make it easier to distribute the works without the permission of their owners. Thus, it is desirable to enable the distribution of retail copies of the works with the ability to control access to and the ability to control who can make copies of these works.

These digital media technologies also allow a consumer to store digital content in non-volatile memory, such as a harddisk drive, in a personal computer and use a software program, applet or plugin, commonly referred to as a media player, to play the music using the multimedia resources of a personal computer. Well known media players for audio and video technologies such as MP3 include the Quicktime media player available from Apple Corporation of Cupertino, Calif. and WinAmp available from NullSoft, Inc. of San Francisco, Calif. These products allow a user to play encoded audio on a personal computer. In addition, there are many media player devices, such as the Rio and ReplayTV brands of products available from SonicBlue, Inc. of Santa Clara, Calif. that enable a consumer to store and play encoded audio or video (such as MP3 and other formats) in a portable device or standalone device. These electronic devices typically store the encoded audio in a flash memory or a harddisk drive that allows for non-volatile storage of the audio and video and allows the encoded audio or video to be erased or over written. It is desirable to enable the owner or authorized distributor of digital content to control how digital content stored in a personal computer or a media player device can be accessed and copied by the user.

Accordingly, it is an object of this invention to provide an improved method and system for distributing digital content.

It is another object of the present invention to provide an improved method and system for distributing digital content that can control the unauthorized copying or redistribution of the digital content.

It is yet another object of the present invention to provide an improved method and system for managing the electronic distribution of works in digital form over a network such as the internet.

### SUMMARY OF THE INVENTION

The present invention is directed to a method and system for distributing digital data representing audio, video and text works or portions of a work (hereinafter referred to as digital content) over a private or public network, such as the Internet. The method and system according to the invention can allow a user to input digital content into the system and to define how other users can access and use a given unit of digital content, distribute a particular unit of digital content to those users who have been granted access and control the level of access that each user can be given.

The system according to the invention can include four components, three user components and at least one gateway component. The user Desktop component protects media and assigns rights. The user Player component interprets those rights and allows playing or viewing of the protected works. The Gateway component stores and forwards digital certificates, tickets, and the digital content. The user Administration (Admin) client component is used for system-wide management.

The Desktop component works in conjunction with a Gateway component to upload and download digital content and to retrieve an address book of available users. Each Desktop component registers with the Gateway component by generating a digital identifier or digital ID that is certified by the Gateway component. The digital ID can include a public ID and a private ID. The public ID can include a public key that can be used encrypt Tickets that can be used to control access to works stored on the Gateway component. The private ID can include a private key that can be used decrypt the Tickets that can be used to gain access to digital content received from the Gateway component. The public ID can be stored in the address book of users at the Gateway component. The private ID can be stored at the client component. The digital ID can be generated as a function of characteristics of the Desktop component such that changes to the Desktop component may require a new digital ID to be generated.

Once a Desktop component is registered and certified with the Gateway component, the Desktop component can be used to import digital content into the system and define access rights for other users of the system. The Desktop component can generate a symmetric key that can be used to encrypt the digital content that can be stored at the Gateway component. The Desktop component can identify a user from a list of users registered with the Gateway to allow that user access to the encrypted digital content. For each user, a ticket, encrypted using the user's public key, is created and sent to the user via the Gateway. The ticket can contain the symmetric key that can be used to decrypt the digital content and access rights information used by the Desktop or Player component to control a user's access rights to the decrypted digital content.

In order to access an element of digital content within the system, a user must obtain a ticket that was generated for that user by the Desktop component. The Gateway component facilitates the transfer of tickets and their associated digital content between client components.

The player component can be used to enable a user to playback audio or video works or view the textual work that is encoded in the digital content. The Player component can have its own public ID that can be used by a Desktop component to create a ticket for a particular piece of digital content that can be transferred via a Gateway component to the Player component. The Player component can use its private ID to decrypt the Ticket, retrieve a symmetric key that can be used to decrypt the digital content and feed the decrypted content to be played back or viewed as permitted by the rights defined by the ticket. The ticket, can for example define how many times the digital content can be played back, whether it can be edited or establish dates for editing, viewing or redistribution.

The Admin component can be used to manage the Gateway component and to establish user accounts. Once a user account is established, that user can utilize a Desktop component to add or remove digital content to the system or a Player component to play back digital content managed by the system.

The system can include a plurality of Gateway components and two or more Gateway components can be configured to establish trusted relationships that permit them to share user lists and mirror digital content in order to provide scalability, redundancy and high availability.

The system according to the present invention can be implemented as a client-server environment or a peer-to-peer environment. The Desktop component can include a player component that allows a user to view or playback digital content. The Player component can include an access control or rights management component which evaluates access control or rights management information and determines whether a user can play back, edit, redistribute the digital content in encrypted or unencrypted form or otherwise access the digital content.

The method according to the invention can include establishing a new user on a Gateway component, the user utilizing a Desktop or Player component to establish public and private IDs, sending the public ID to the Gateway component for certification. After a user has been certified at a particular user component, the user can input digital content as well as access digital content within the system. To input digital content, the method includes authenticating the user, importing the digital content into the system, generating a symmetric key, encrypting the digital content with the symmetric key and forwarding the encrypted digital content to the Gateway. For each user who is granted access to the digital content, a ticket is generated and sent through the Gateway to the user client component. To generate an encrypted ticket for a user, the user is authenticated and the Desktop client obtains the public ID of the user from the Gateway. Then, using the user's public key, the Desktop client encrypts a ticket containing the symmetric key of the digital content along with the access rights of that user.

To access digital content, the method includes authenticating the user, receiving the encrypted digital content and the encrypted ticket, decrypting the ticket (and the digital content's symmetric key) with the user's private key and using the symmetric key to decrypt the digital content and input the decrypted digital content to the play back system as permitted by the user's defined access rights provided by the ticket. The method can include evaluating the access control or rights management information in the ticket and determining whether the user can access the decrypted digital content to play it back or otherwise view it, edit it or redistribute it in encrypted or unencrypted form.

### BRIEF DESCRIPTION OF THE DRAWINGS

The foregoing and other objects of this invention, the various features thereof, as well as the invention itself, may be more fully understood from the following description, when read together with the accompanying drawings in which:

FIG. 1 is a diagrammatic view of a system for distributing digital content over a network according to the present invention; and

FIG. 2 is a diagrammatic view of a method for distributing digital content over a network according to the present invention;

### DETAILED DESCRIPTION OF THE PREFERRED EMBODIMENTS

The present invention is directed to a method and system for distributing digital content representing audio recordings, video recording and books (and other textual works) or portions thereof, over a private or public network, such as the Internet. The method and system according to the invention allow for a user to input one or more works into the system, to define the level of access that a user is provide to a given work, distribute a particular work to those users who have been granted access and control the level of access that each user can be given. In order to illustrate the application of the invention and to facilitate a better understanding of the invention, the invention is described below as embodied in a method and system for distributing music within a music producing organization. While the invention is suited for distributing copyrightable works (such as, for example, music, audio, video and text) in electronic form within an organization, a person having ordinary skill in the art will appreciate that the invention can also be embodied in a method and system for distributing digital content over a network such as the internet to consumers and retail customers.

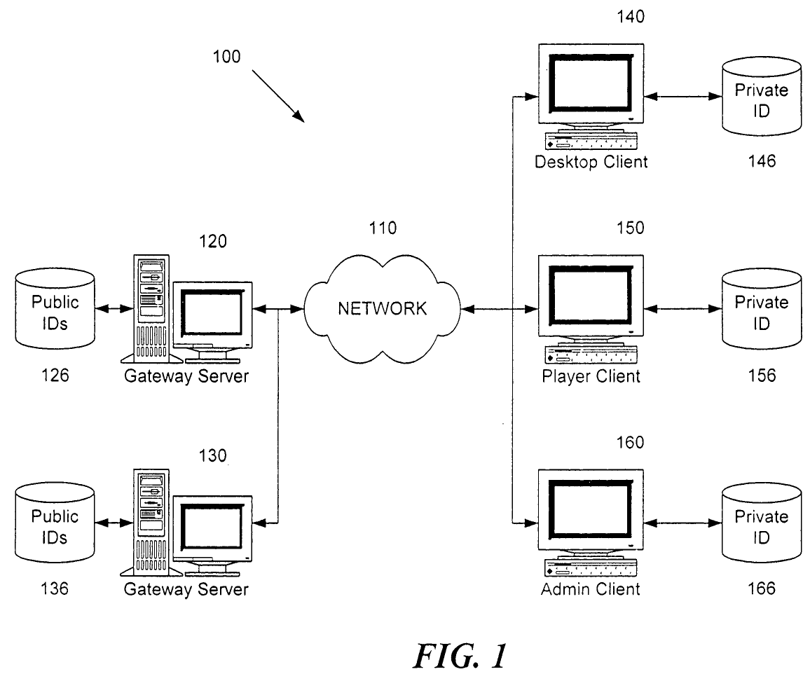

FIG. 1 shows a system 100 for distributing music over a network 110 (such as the internet) in accordance with the present invention. The system 100 includes a first gateway server 120, a second Gateway server 130, a desktop client 140, a player client 150 and an admin client 160 connect by a communications network 110, such as IP network, for transferring data between the gateway server computers 120 and 130 and the client computers 140, 150 and 160.

In the illustrative embodiment, the desktop client 140 can be used by a music producer at a music studio during the recording of one or more songs for record album and the player client 150 can be used by an execute in the same organization who oversees the recording project or musicians. In this embodiment, the recording studio is located in Nashville, Tenn. and the executive has to stay in New York City, N.Y. to attend to other business and is unable to travel to the studio.

The first gateway server 120 can include a gateway server computer program that is adapted for storing and managing user accounts and their associated public IDs, and for certifying each new client computer as it registers with the gateway server program. The gateway server computer program can also be adapted for storing encrypted digital content, preferably music encrypted with a symmetric key, and for facilitating the transfer of a ticket to a client computer to enable a user to decrypt and access the digital content. The gateway server can also store the public ID associated with a particular user using a client computer and can distribute a user's public ID to allow others to grant the user access to music imported to the system. The gateway server also stores, temporarily, the tickets generated by the desktop client that define the access granted to a user. Once a user logs into the gateway server on the system, the ticket is transferred and stored at the client system.

The second gateway server 130 can include a similar gateway server computer program that is adapted to provide the same functionality as the gateway server computer program on the first gateway server 120. In addition, the computer programs on the first and second gateway servers 120, 130 can be linked or configured to establish a trusted relationship that allows the servers to share user lists and public IDs and mirror digital content. The gateway servers in a system can be configured to provide redundancy whereby if one gateway server fails, the other can take over. Alternatively, the gateway servers can be configured to allow the operational load to be distributed between the two or more computers.

The admin client computer 160 can include an admin client computer program that is adapted for communicating with one or more gateway servers in a system and interacting with a gateway server computer program to allow a user, such as a system administrator, to add and remove system users as well as configure the operation of the gateway server computers 120 and 130 and define operational relationships between the gateway servers 120 and 130. The admin client computer program allows an administrative user to remotely manage all the functions performed by any of the gateway servers connected to the network.

The admin client computer program can be used to define one or more separate workspaces on each gateway server or group of gateway servers. A workspace can be defined to enable a predefined group of users associated with a common project to setup a secure environment within which to distribute the digital content associated with that project. Thus, for example, the record company could define a separate workspace for each record project or a movie studio could define a separate workspace for each movie production in progress. In addition, any two or more workspaces could have one or more users in common, if those users were involved in each of the projects.

The Desktop client computer 140 can include a desktop client computer program that is adapted for interacting with the gateway server computer program to allow a user to register the Desktop client computer 140 with a gateway server 120, allow the user to import music or other digital content into the system (or a workspace) and generate tickets in order to define how other users can access that music.

The desktop client computer program can include a registration component adapted for generating a public and private key pair that can be used to encrypt and decrypt tickets that can be used to control access to the digital music distributed by the system 100. The public and private key pair can be part of digital identifier or digital ID used to certify the user and the associated desktop client computer 140 for access to the system 100. The digital ID can be generated as a function of characteristics or attributes of the desktop computer 140 and can be used to uniquely identify the desktop computer 140 to the gateway server 120. For example, the registration component can use the MAC (media access control) address or the CPU ID of the desktop client computer 140 to generate the public and private key pair the digital ID.

The digital ID can include a public ID and private ID, each taking the form of an XML document. The private ID, stored at the client, is fingerprinted or keyed to characteristics of the client computer and if these characteristics become changed, a new digital ID would need to be created. The public ID is forwarded to the gateway server where can be signed and stored for distribution to desktop client computers 140 to enable others to grant the user access music imported to the system.

The public ID can be signed or otherwise certified by the gateway server using any well know method. The certification can be as simple as being added to a list of certified public IDs or each public ID can include a certification value or attribute (added by the gateway server) which can be separately verified by communicating with the gateway server. Alternatively, the gateway can include a public ID (which includes a public key) for itself in its user list and transfer that public ID to the client with other users public IDs. The gateway server can encrypt, using its private key, each of the users public IDs such that each client computer program would have to use the gateway servers public key to decrypt the public ID of each user, an error indicating an uncertified public ID.

The desktop client computer program can further include a symmetric encryption/decryption engine that can be used to encrypt and decrypt the music or other digital content that is imported and made available within the system. After a user has registered the desktop client computer 140 with the system 100, the user can then input music and other digital content to the system as well as retrieve music and other digital content for playback. The desktop client computer program can use the symmetric encryption/decryption engine to generate a symmetric key that can be used to encrypt music that is imported to the system 100. For each user assigned access rights to that music, the public key obtained from the user's public ID can be used to encrypt the symmetric key and other information in the form of an encrypted ticket that is distributed to each user through the gateway server 120.

The Player client computer 150 can include a player client computer program that is adapted for communicating with and interacting with the gateway server 120 and the gateway server computer program to retrieve music and an associate ticket to enable playback. The player client computer program registers with the gateway server the same way the desktop client does, namely generating a digital ID, keyed to the player client computer 150 as a function of one or more characteristics (e.g. MAC address or CPU ID) of the player client computer 150 and registering the public ID with the gateway server.

In order to play a song using the player client 150, the user must be authenticated, such as using a login ID and password, to the player client 150. Upon successful user login, the player client computer program establishes communications with the gateway server computer program to determine whether the user has been registered on the player client computer 150 to access music on the gateway server 120. If the user is registered, the gateway server computer program will identify the tickets and associated music that the user has been given access to. Where the user is registered to multiple gateway servers, the client computer program can communicate with each gateway server to identify the tickets and associated music for the user on each server.

The user can select a particular song for playback and the player client can request that the encrypted song along with the user's ticket for that song are sent to the player client computer 150 and stored in the hard drive or other non-volatile memory of the player client 150. The player client computer program can use the private key in the users private ID to decrypt the ticket. The decrypted ticket includes the symmetric key that can be used decrypt the song for playback and the access control or rights management information that can be used by the player client computer program to determine whether playback is permitted. If playback is permitted, the song can be decrypted and played using an audio processing software program (such as the QuickTime media player available from Apple Computer Corporation of Cupertino, Calif.) to allow the user to listen to the music.

In one embodiment, the server computers 120 and 130 can be computers based upon the Intel Pentium computer architecture, such as servers available from the Hewlett-Packard Company, Palo Alto, Calif., Compaq Computer Corp, Houston, Tex., running the Microsoft Windows Operating System available from Microsoft Corporation, Redmond, Wash. The gateway server computer program can be written in the JAVA programming language and run on the J2EE Architecture (from Sun Microsystems of Palo Alto, Calif.).

In one embodiment, any or all of the client computers 140, 150 and 160 can be an be computers based upon the Intel Pentium computer architecture, such as computers available from Hewlett-Packard Company, Palo Alto, Calif., Compaq Computer Corp, Houston, Tex., running the Microsoft Windows Operating System available from Microsoft Corporation, Redmond, Wash. The client computer programs can be written in the JAVA programming language and run on the JAVA Virtual Machine (from Sun Microsystems of Palo Alto, Calif.) that is provided with many computer operating systems including Microsoft Windows.

Alternatively, any or all of the client computers 140, 150, and 160 can be MacIntosh computers available from Apple Computer Corporation running the Apple MacIntosh Operating System. The client computer programs can be written in the JAVA programming language and run on the JAVA Virtual Machine (from Sun Microsystems of Palo Alto, Calif.) which is provided with many computer operating systems including the Apple Macintosh Operating System.

Further, the player computer 150 can be a portable media player device or set top box device adapted to communicate with the gateway server to allow playback of the music or other digital content in accordance with the invention.

The symmetric encryption/decryption engine can be an AES certified algorithm, such as the Rijndael symmetric encryption algorithm using 128, 256 or 512 bit key length.

The asymmetric encryption/decryption engine can be a public/private key encryption algorithm. In one embodiment, the asymmetric encryption algorithm is the RSA public/private key encryption algorithm using 1024 or 2048 bit key length, available from RSA Security, Inc. of Bedford, Mass.

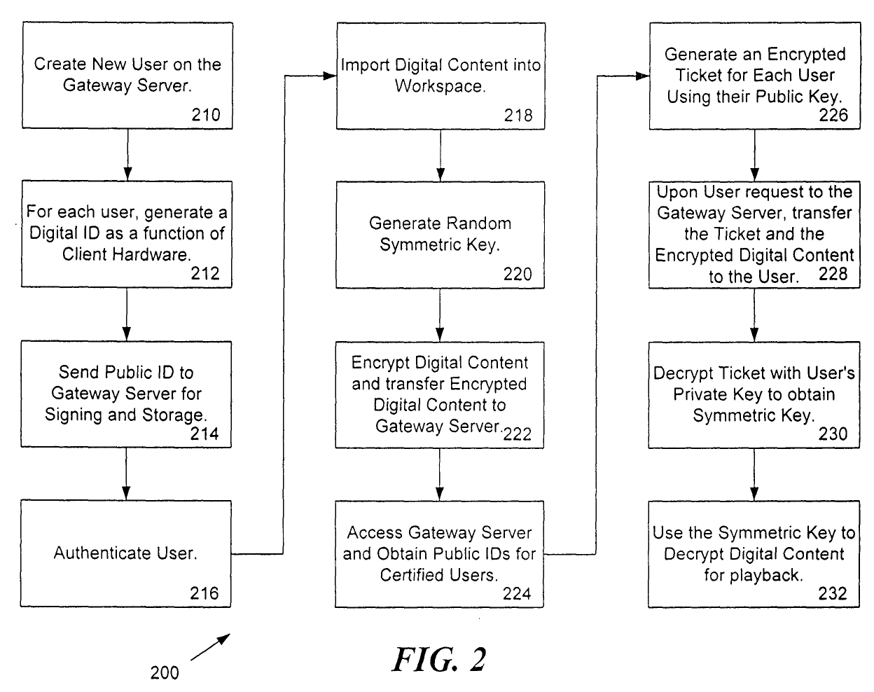

FIG. 2 shows a method 200 for distributing music (audio, video or text) over a network (such as the Internet) in accordance with the present invention. The invention can be implemented by a client-server computer system as described above, or the invention can be carried out on peer-to-peer computer system as is well known.

As shown in FIG. 2, before a user can access the system, a user account should be created on the gateway server, 210. Once a user account is created, the user can connect to the gateway server using a client computer. The first time the user (using the client computer) connects to the gateway server on a client computer, the client computer software generates a digital ID that includes a public ID and a private ID as a function of characteristics of the client computer (such as the MAC address or CPU ID), at step 212. The client computer sends the public ID to the gateway server and the gateway server signs the public ID and adds the public ID to the user address book to allow other users to grant the user access to digital content at step 214. Thereafter, the user will be able to log into the gateway server using the client computer. If the characteristics of the client computer used to create the digital ID change, a new digital ID would have to be created.

Once the digital ID is created for the user on the client computer, the user is authenticated using a login ID and password at step 216. After the user is authenticated, the user can use the desktop client to import digital content into the system, at step 218. At step 220, the desktop client computer software generates a symmetric key used to encrypt the digital content. The encrypted digital content is transferred to the gateway server at step 222.

Next, the user selects one or more other users to grant access to the imported digital content. At step 224, the gateway server provides the desktop client with a list of users to select from. For each user selected, an encrypted ticket is generated at step 226. The encrypted ticket includes the symmetric key used to encrypt the digital content and access control or rights management information for that user. The encrypted ticket and the encrypted digital content is transferred to the user at step 228. The ticket is decrypted using the users private key to obtain the symmetric key at step 230. The digital content is decrypted using the symmetric key at step 232. The player client can also limit or control decryption and playback of the digital content in accordance with access control and rights management information provided in the ticket at step 232.

As one of ordinary skill will appreciate, the system of the present invention can be used to distribute works (audio, video or text) in a business to business context as well as a business to consumer or customer context.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. An apparatus for distributing a unit of information representative of a copyrightable work over a network, said apparatus comprising:
a gateway computer adapted for storing said units of encrypted information representative of copyrightable works;
a desktop computer, connected to said gateway component via said network, including a computer system, associated memory, and user desktop software, said desktop software being adapted to encrypt using a symmetric key and send said encrypted unit of information to said gateway computer and said desktop software being adapted to encrypt, using a first asymmetric key associated with a user, a ticket comprising said symmetric key;
said first asymmetric key of said user being associated with a second asymmetric key of said user, wherein data encrypted using said first asymmetric key can be decrypted using said second asymmetric key.
